(19) United States
(12) Patent Application Publication
(10) Pub. No.: US 2014/0165522 A1
(43) Pub. Date: Jun. 19, 2014

(54) CONVEYORS MODULE FOR SUGAR-CANE HARVEST AND HARVESTING PROCESS

(71) Applicants: Oscar Antonio Braunbeck, Sao Paulo (BR); Efraim Albrecht Neto, Sao Paulo (BR); Guilherme Ribeiro Gray, Sao Paulo (BR); Jose Leonardo Camargo De Campos, Sao Paulo (BR)

(72) Inventors: Oscar Antonio Braunbeck, Sao Paulo (BR); Efraim Albrecht Neto, Sao Paulo (BR); Guilherme Ribeiro Gray, Sao Paulo (BR); Jose Leonardo Camargo De Campos, Sao Paulo (BR)

(73) Assignee: Centro Nacional de Pesquisa em Energia e Materiais CNPEM, Sao Paulo (BR)

(21) Appl. No.: 14/130,802

(22) PCT Filed: Jul. 3, 2012
(86) PCT No.: PCT/BR2012/000229

§ 371 Date: Jan. 3, 2014

(30) Foreign Application Priority Data
Jul. 4, 2011 (BR) PI 1103567-6

(51) Int. Cl. A01D 45/10

(52) U.S. Cl. CPC A01D 45/10
USPC 56/10.6; 56/60; 56/14.5; 56/13.7

(57) ABSTRACT

The present invention relates to a harvesting conveyors module, particularly appropriate for sugar cane harvesting, comprising a lifting mechanism (1) arranged horizontally and able to be vertically moved; a base cutting mechanism (7); a deflector mechanism (6) arranged above the lifting mechanism (1) and configured to deflect and aid the displacement of cutted stems to a pulling mechanism (9), said pulling mechanism comprising conveyors, an upper conveyor (10) and a lower conveyor (11); a lifting roll (8) placed near to the lower end of the conveyors (10, 11); a transferring mechanism (12) appropriate to receive the stems from pulling mechanism (9) and transfer them to a chopper mechanism (13), said chopper mechanism (13) being arranged in sequence to the said transferring mechanism (12), and a stretcher mechanism (14) acts on the upper conveyor (10) of the pulling mechanism.

The invention also relates to a process for sugar cane harvesting with a module, such process minimizing the forces applied onto the root.

The present invention relates to a module for sugar cane harvesting, which is attachable to a tractor or a complete harvester, self-propellant. The invention also relates to a process for cane harvesting.

### BACKGROUND ART

The feeding of the cane harvester consists of the process of removing the sugar cane stems from plantation and its introduction into the equipment, in an ordered parallel arrangement.

The cane stems, inside the sugar cane plantation, can be oriented in many arrangements, varying between a vertically orderly position, in the erect cane fields, up to a randomicaly messed up arrangement in the strongly lying down cane fields. Frequently there are both cases inside the same stripe of land which indicates that the harvest equipment must have skills to process both configurations.

The harvesting processes currently existing require that the stems be ordered in parallel to each other, both as in harvest of chopped cane as in whole cane. In the first case the parallel ordering is needed to get a uniform chopping length, and in the second case, the parallel ordering is needed to get an economically acceptable charge density.

The mechanized harvesting processes from background art harvesters, particularly of the Australian chopped cane harvesters (see Figure A—Australian chopped cane harvester) begins with the tips cutting, optional operation, when executed, releases the material in the ground, or when off, it feeds the tips together with the stems. After removing the tips, the stems are bent by the action of a static or rotary deflector and, following, two discs with peripheral knives execute the basal cutting, releasing the stems from the clumps, which allows them to lie down over the ground or over the nearby still standing stems. As the harvester moves forward, and with the aid of the cutting discs of base, the stems reach a lifting roll mechanism followed a cleaning rolls sequencing that drives them up to the chopper. When the cane is harvested without previous burning, and without removing the tips, the synchronous chopper cuts leaves and tips in fragments, which are pneumatically separated by a blowing air upward stream produced by an axial flow extractor.

GB 317352 describes a sugar cane harvester comprising a pushing mechanism 11, 12; a base cutting mechanism 4; a concentrating mechanism 5; a puling mechanism with an upper conveyor 9 and a lower conveyor 6; a transferring mechanism 7 which receives the stems and transfer them to a chopper mechanism 8.

U.S. Pat. No. 4,154,047 shows with more detail the harvester already shown in figure A. One can see in the U.S. patent a tips cutter 21, a lifting mechanism 22, an alignment device 84, feeding rolls 64, 70, 72, 74 and 76, a stem cutter 28, a primary extractor 32 and a secondary extractor 36.

### DRAWBACKS OF THE HARVESTERS FROM BACKGROUND ART

The prior art harvesters, particularly the Australian chopped cane harvesters (figure A e U.S. Pat. No. 4,154,047), find difficulties to harvest multiple lines of lied down, very tangled canes. These canes are identified by the producers as canes of low “harvestability”. However, these cases have a tendency to become more frequent due to the good vegetative growth, in that progressively more productive varieties are developed. The figures B and C show examples of tangled stems. Entangle of curved canes produces an interaction or link between stems in contact that difficult its removal.

The figure D shows the active working forces upon stems, when removing them by the prior art chopped cane harvester. The said device is called line separator, or helical separator, or lollipop. It is observed from figure B that line separators are in a position near to the vertical and push the stems in the direction of the harvester displacement, up to align them longitudinally in the direction of the movement.

When the stems are difficult to slide over line separators, one generates flexing forces Ph and Pv applied upon an intermediary point of the stem, wherein said forces often has enough magnitude to cause stem breaking or root plucking.

Moreover, the chopped cane harvesters push and lie down the stems to be aligned longitudinally (combed) in a too close position from ground surface, allowing them to receive contamination from soil mineral impurities moved by the basic cutter. This big soil volume is partially cleaned from stems as they passes through the cleaning rolls, provoking a big power demand and reducing the sucrose extraction efficiency.

In the harvester of GB 317352 it occurs the same shortcomings already cited, that is, the pusher mechanism pushes the stems forward until tilt them longitudinally causing breakage or tearing of the stems at the root. This drawback becomes even more relevant in the case of tangled stems, tilted and toppled sideways.

### OBJECTIVES AND ADVANTAGES OF INVENTION

The object of the present invention is reducing the losses of raw material and the power demand, by the use of a new harvesting module.

Figure E shows a new harvesting principle obtained with the module in accordance with the present invention. The new principle effects the removal of the stems from plantation applying forces Fh and Fv, straightly on stem base, in order to produce a force configuration as illustrated in Figure E. This configuration of forces is more simple and less aggressive to stem resistance than that one shown in Figure D, which represents the principle used in chopped cane harvesters from prior art. The charge condition in Figure E shows predominantly traction forces applied at the end of stem instead of flexing charges applied upon an intermediary point of said stem, as shows the figure D. In the case of chopped cane harvesters of the prior art, the line separators push (combs) the stems in the direction of the harvester displacement, up to align them longitudinally in the direction of the movement.

To capture a stem it is necessary to know its location in the distribution of the plantation. The only point of a stem the location of which is known, is the point of stem insertion in the ratoon. This point is where the base cutting happens. In the module according the invention, the stem is captured and pulled from this point, and, hence, the removal process becomes quite indifferent to the falling degree of the canes. As the removal process goes forward pulling the stems towards a common point, the parallel ordering will spontaneously happen.

The objective of the invention is reached through a harvesting conveyors module, which comprises a lifting mechanism arranged horizontally and able to be vertically moved; a base cutting mechanism; a deflector mechanism arranged above the lifting mechanism and configured to deflect and aid the displacement of the cut stems to a pulling mechanism, said pulling mechanism comprising conveyors, an upper conveyor and an lower conveyor; a lifting roll situated near the lower end of the conveyors; a transferring mechanism appropriated to receive the stems from the pulling mechanism and transfer them to a chopper mechanism, said chopper mechanism being arranged in sequence to said transferring mechanism, and wherein a stretcher mechanism acts at the upper conveyor of the pulling mechanism.

Hence, the module according to the present invention provides a substantial reduction in the harvesting losses, avoiding stem breakings and root plucking.

Another advantage of the module according to the present invention is the fact that the removal process of the stems from plantation is few dependent of the falling degree of the canes, as the stems are cut near to the root.

The process according to the present invention comprises the following steps:

### Process for Harvesting the Erect Sugar Cane

A deflector inclines the cane longitudinally effecting a minimum force at the root of said cane; cut discs cut the cane; a lifting roll lifts the end of the cane and transfers it to conveyors; and the conveyors of a pulling mechanism pull the cane, and a transfer mechanism transfers the cane to a chopper mechanism which cuts the cane in pieces.

### Process for Harvesting the Laterally Bent Sugar Cane

A cut disc cuts the cane without effecting any effort at the root of said cane, and the cane, consequently, falls on the upper surface of a metallic cone of the lifting mechanism; the other end of the cane, consequently, climbs up and touches the lower surface of a deflector mechanism cylinder; the helicoids of the lifting mechanism and the helicoids of the deflector mechanism, through rotation, move the cane up to the conveyors of a pulling mechanism; and the conveyors of the pulling mechanism pull the cane up to a transferring mechanism, and the transferring mechanism transfers the cane to a chopper mechanism which cuts the cane in pieces.

### Process for Harvesting the Laterally Lied Down Sugar Cane

A metallic cone of a lifting mechanism lifts a little the cane, without effecting any effort at the root of said cane; a cut disc cuts the cane, and the cane, consequently, falls on the upper surface of the lifting mechanism; the other end of the cane, consequently, climbs up and touches the lower surface of a cylinder of a deflector mechanism; the helicoids of the lifting mechanism and the helicoids of the deflector mechanism, through rotation, move the cane up to the conveyors of a pulling mechanism; and the conveyors of the pulling mechanism pull the cane, and a transferring mechanism transfers the cane to a chopper mechanism which cuts the cane in pieces.

### Process for Harvesting the Lied Down Longitudinally Forward or Backwards Sugar Cane

The cut disc cuts the cane effecting a minimum force at the root of said cane; a lifting roll lifts the end of the cane and transfers it to conveyors of a pulling mechanism; and the conveyors of the pulling mechanism pull the cane, and a transferring mechanism transfers the cane to a chopper mechanism which cuts the cane in pieces.

The invention will be, next, more in detail described, by way of example, on basis of the attached figures:

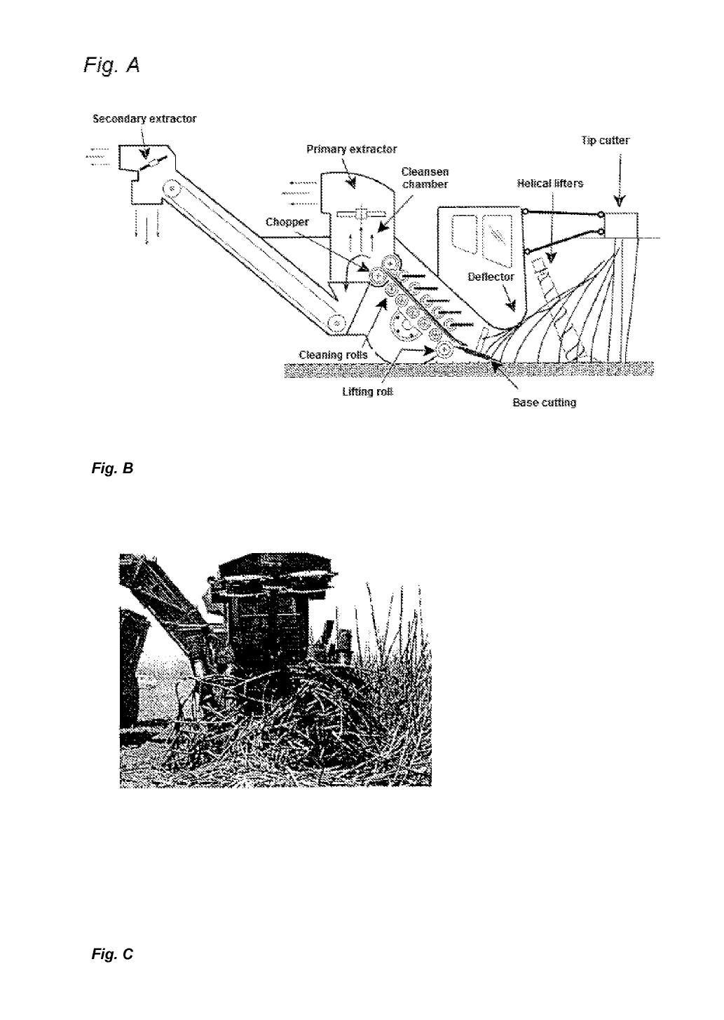

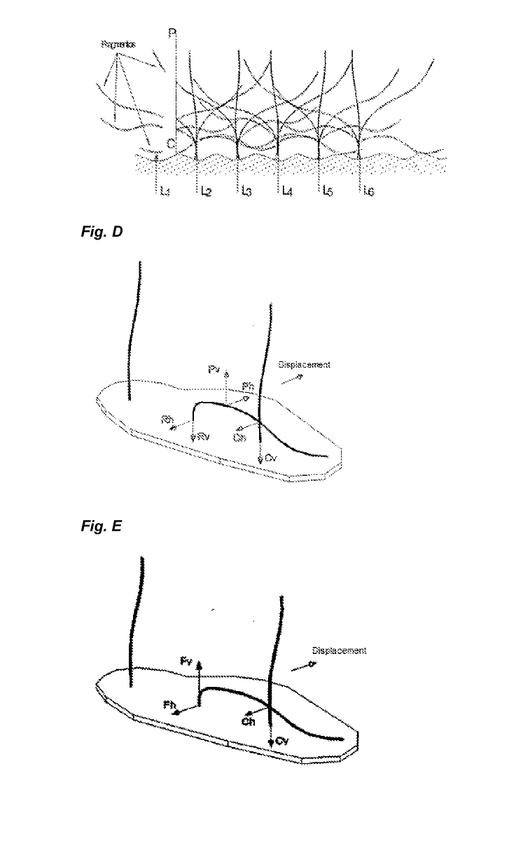

FIG. 1—perspective view of a preferred embodiment of the conveyors module according to the present invention;

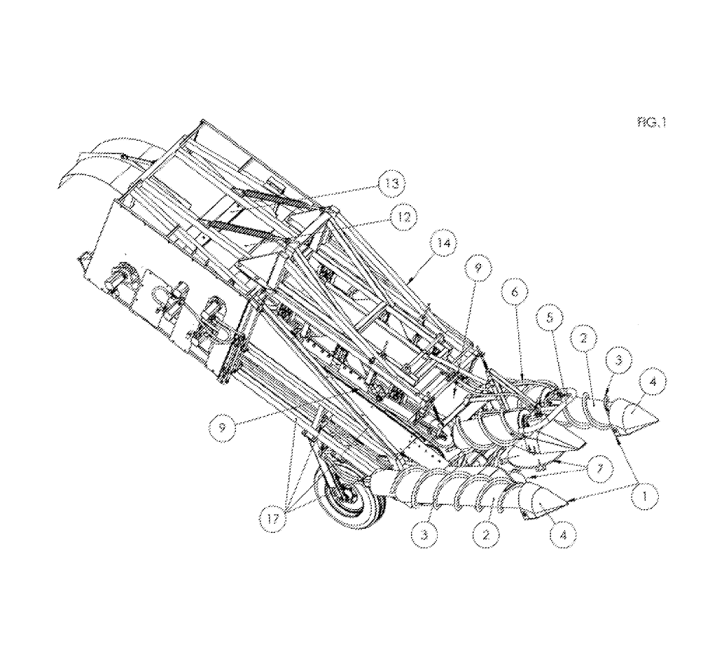

FIG. 2—lateral view of the module of the FIG. 1;

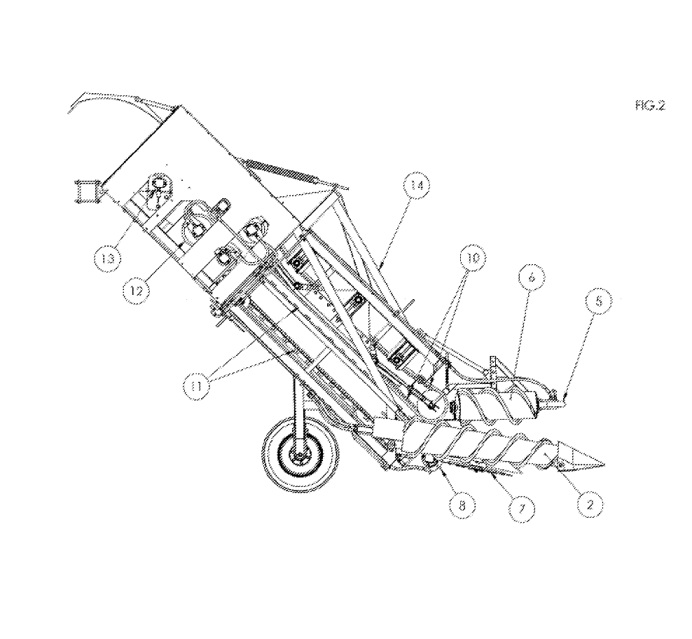

FIG. 3—upper view of the module of the FIG. 1;

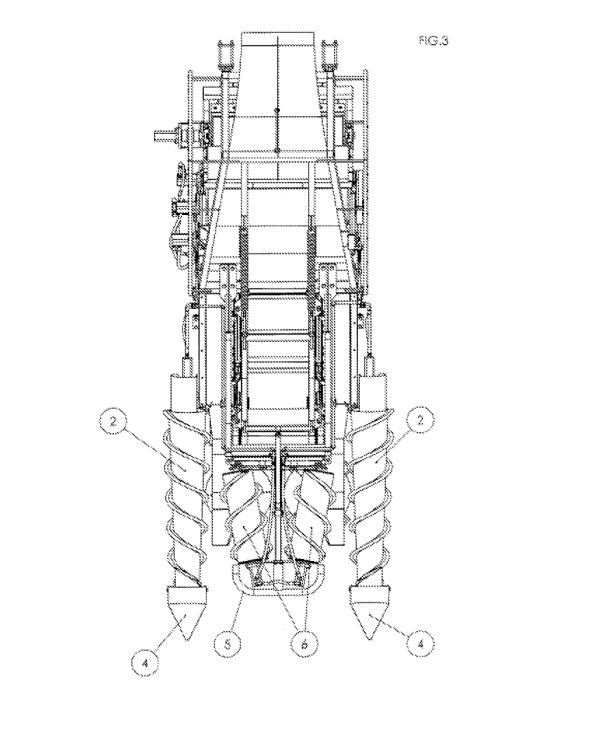

FIG. 4—front view of the module of the FIG. 1;

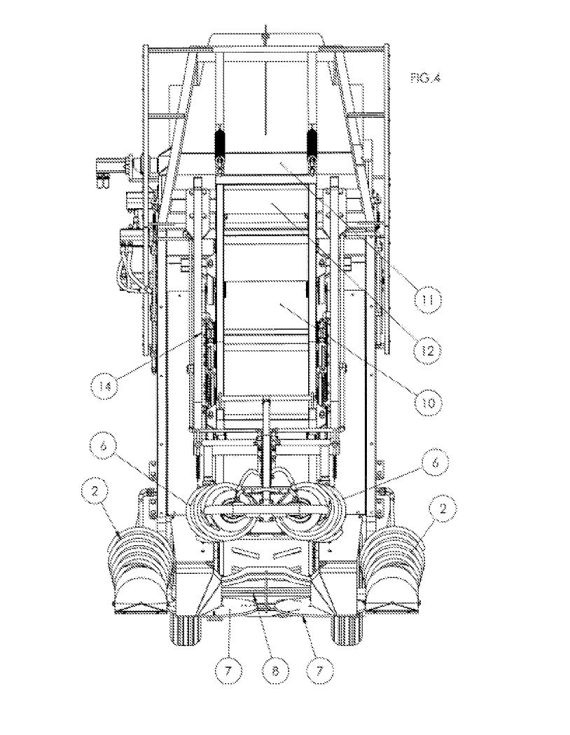

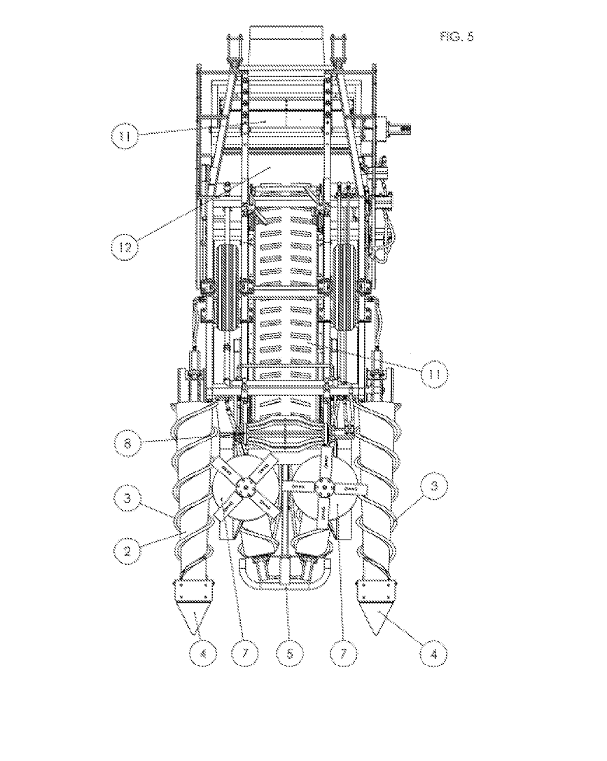

FIG. 5—lower view of the module of the FIG. 1;

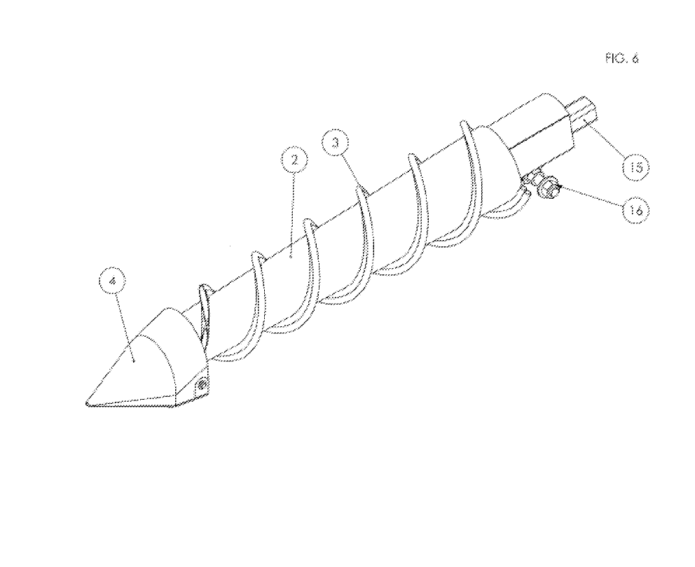

FIG. 6—perspective front view of a preferred embodiment of the lifting mechanism according to the present invention;

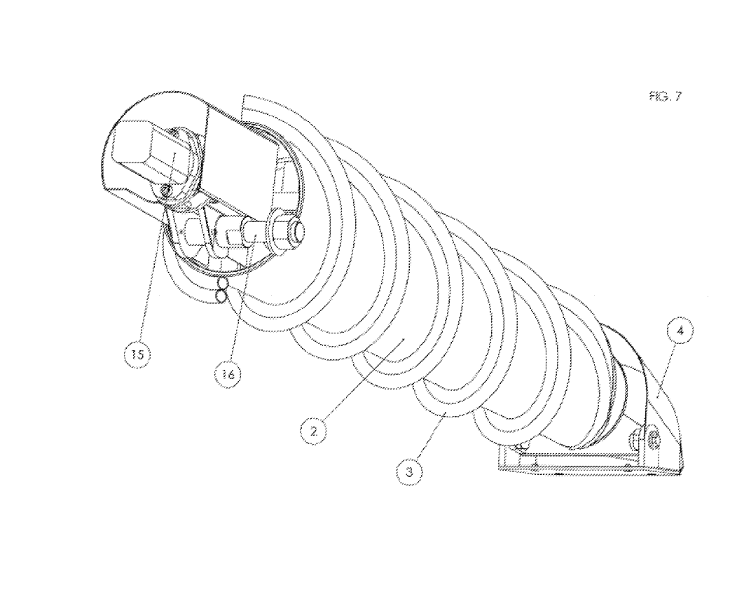

FIG. 7—perspective rear view of the lifting mechanism of the FIG. 6;

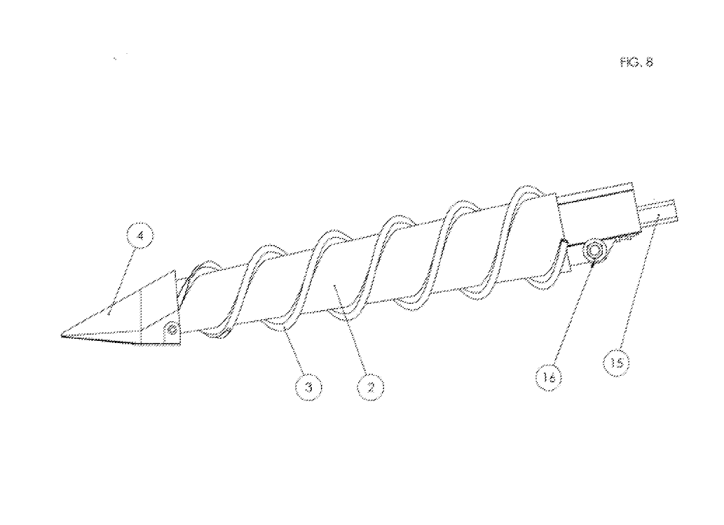

FIG. 8—lateral view of the lifting mechanism of the FIG. 6;

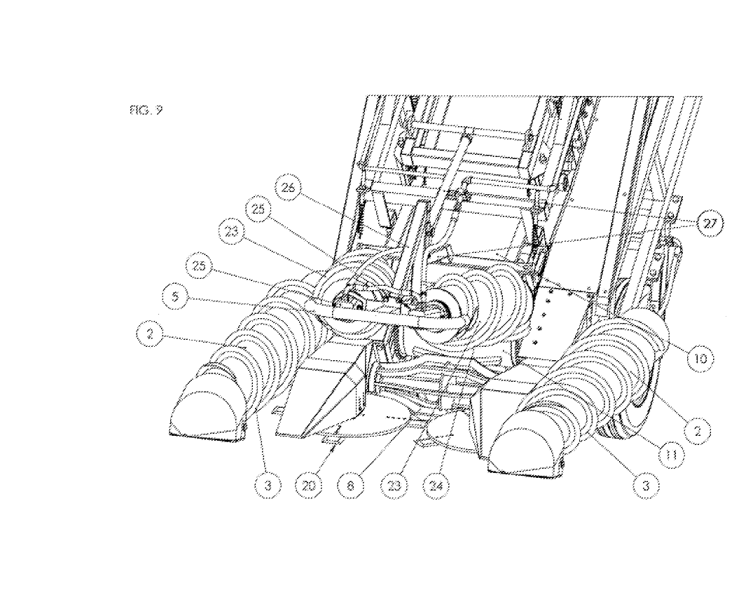

FIG. 9—perspective view of a preferred embodiment of the deflector mechanism according to the present invention;

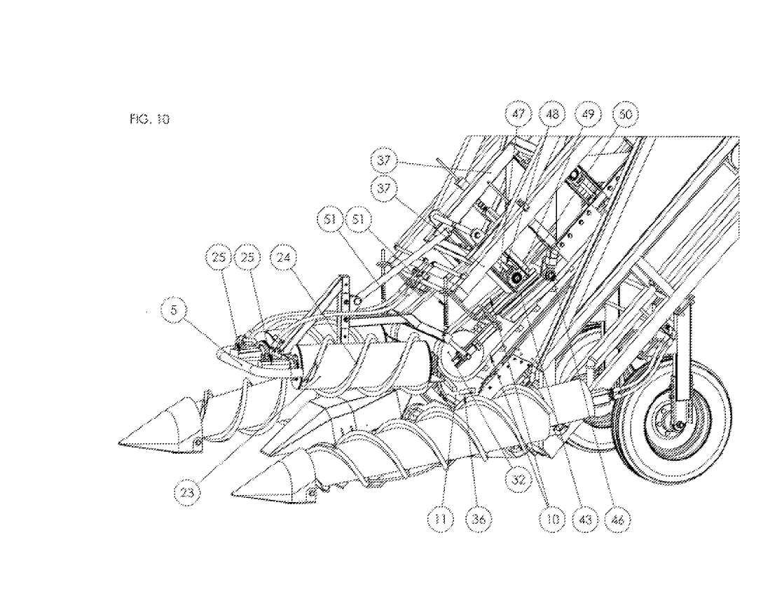

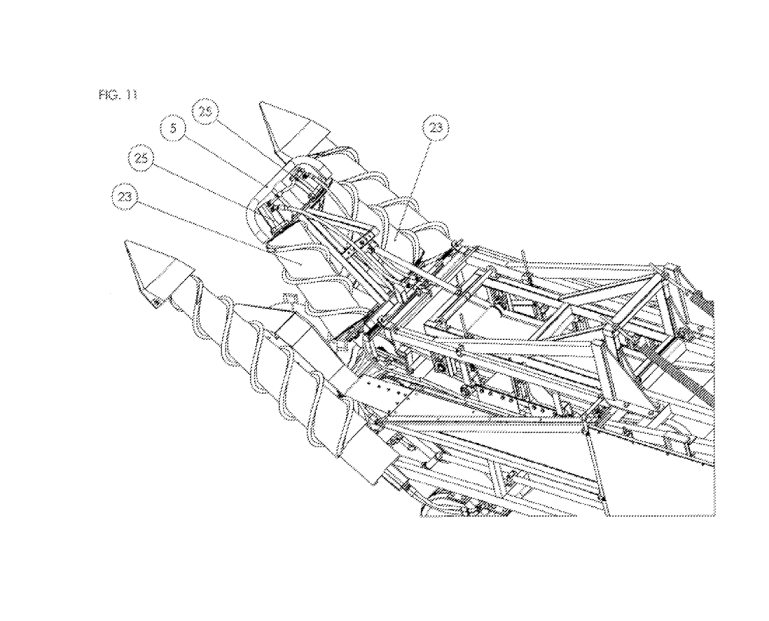

FIG. 10—lateral view of the deflector mechanism;

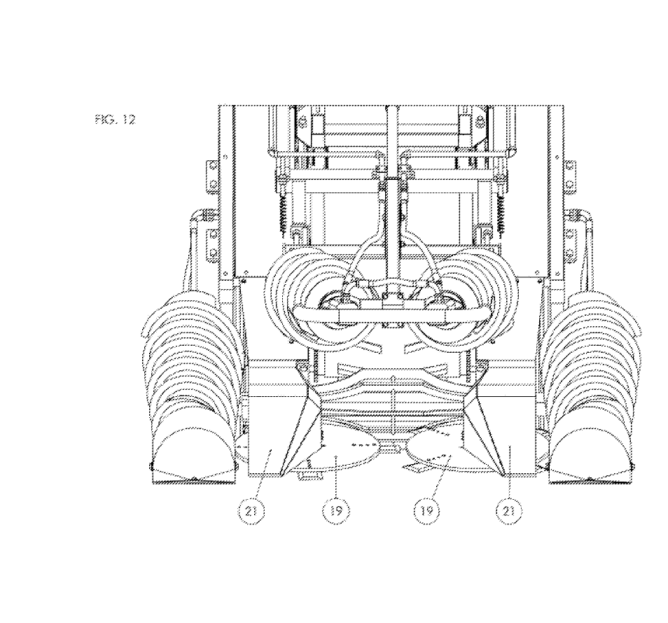

FIG. 11—upper view of the deflector mechanism;

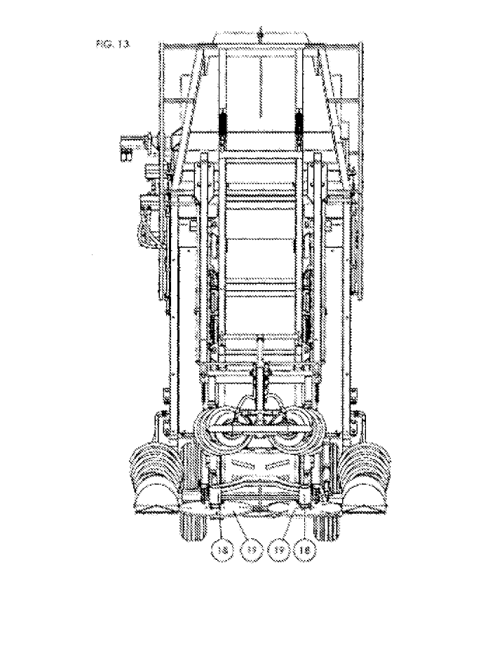

FIG. 12—front view of a preferred embodiment of the base cutting mechanism in accordance with the present invention;

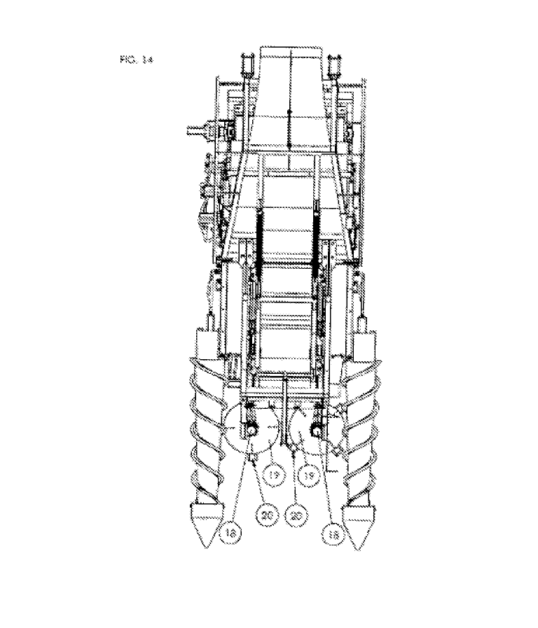

FIG. 13—front view of the base cutting mechanism of FIG. 12 without the protection plates;

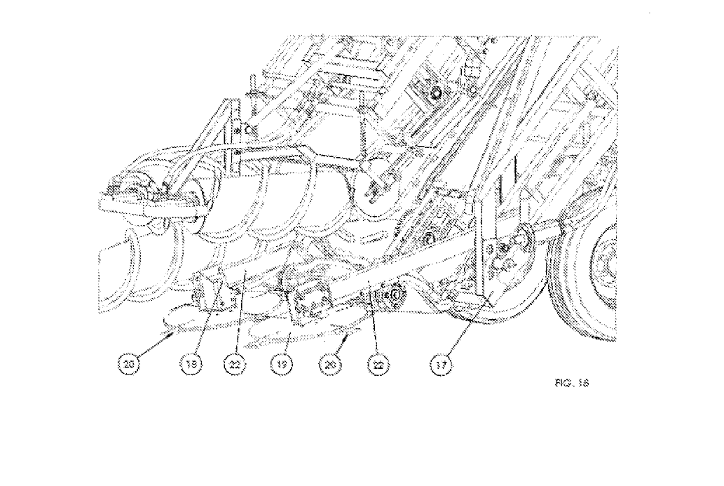

FIG. 14—upper view of the base cutting mechanism of FIG. 12 without the plates of protection and without the deflector mechanism;

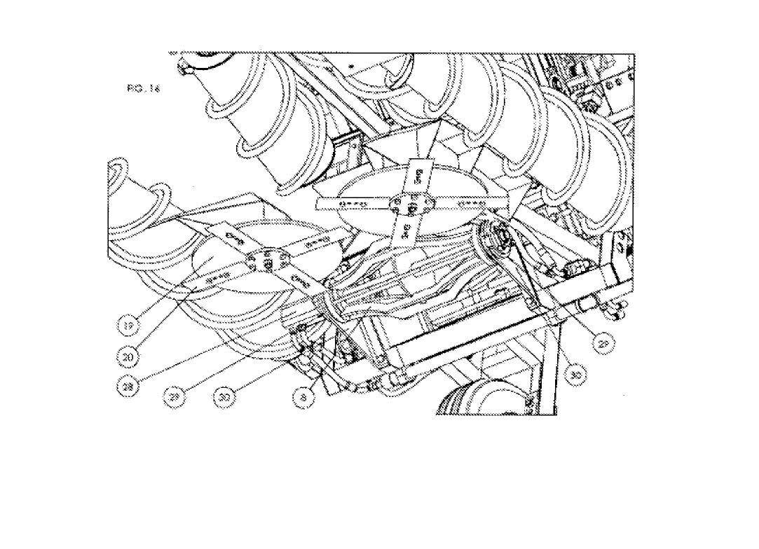

FIG. 15—perspective view of the base cutting mechanism of FIG. 12 without the protection plates;

FIG. 16—lower view of the base cutting mechanism of FIG. 12;

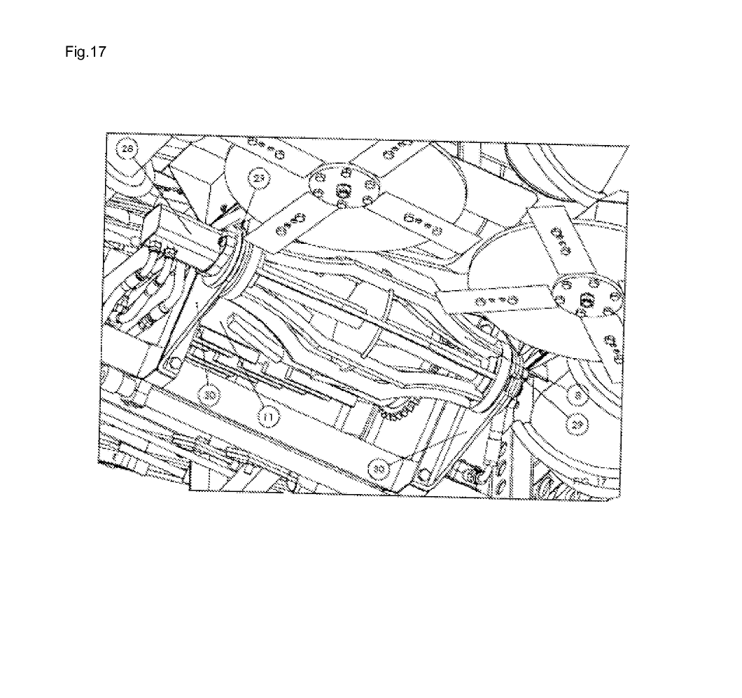

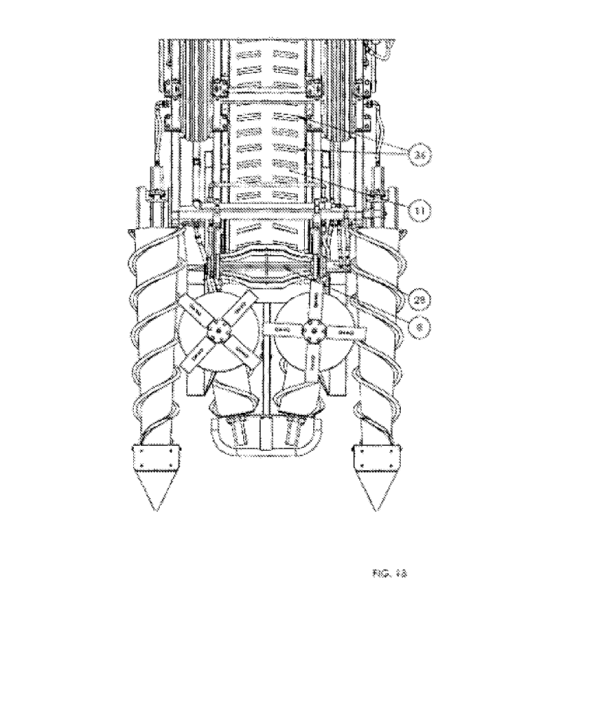

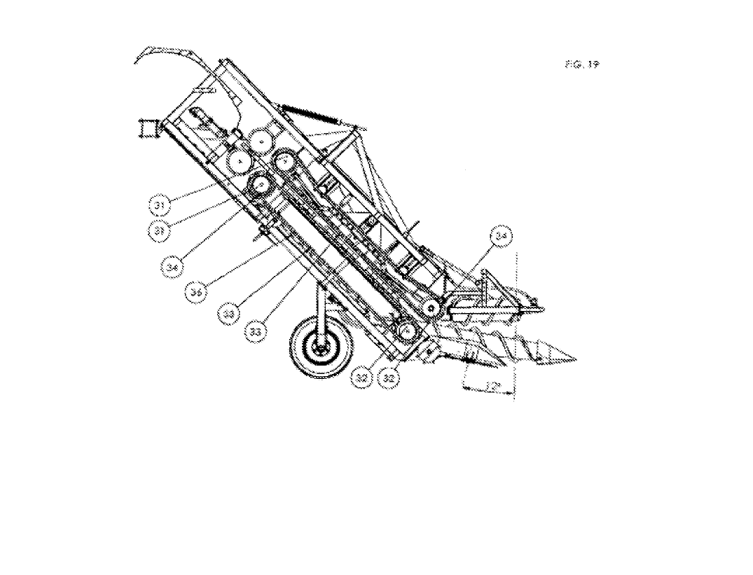

FIG. 17—lower view of a lifting roll in accordance with the present invention;

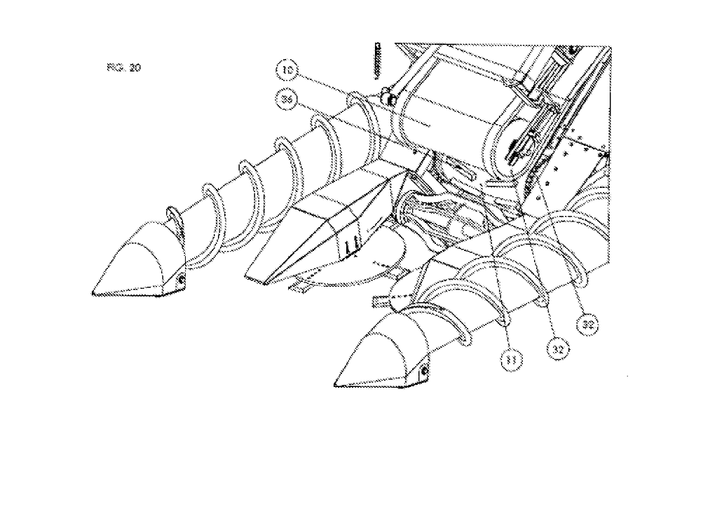

FIG. 18—lower view of the lifting roll of FIG. 17 and of a pulling mechanism according to the invention;

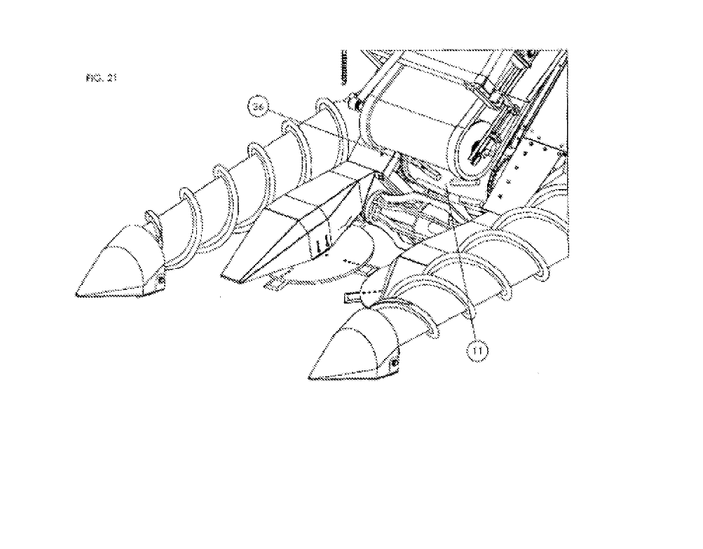

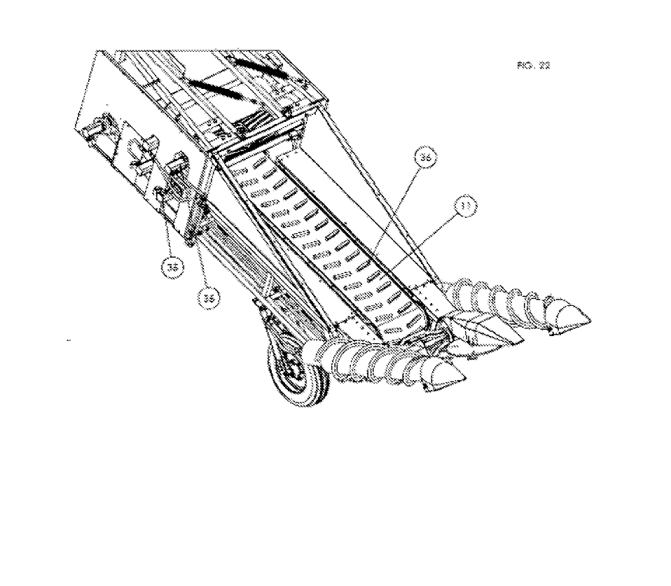

FIG. 19—lateral view of a preferred embodiment of the pulling mechanism in accordance with the present invention;

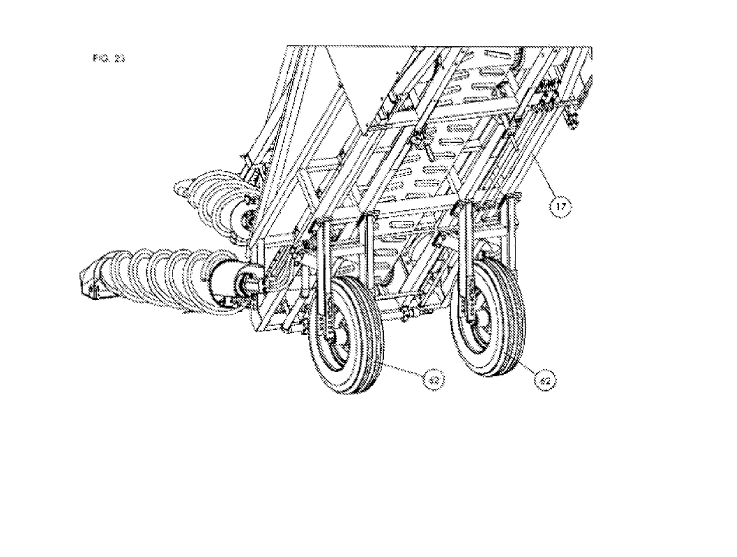

FIG. 20—perspective view of the pulling mechanism of FIG. 19;

FIG. 21—perspective view of the pulling mechanism of FIG. 19 without the upper conveyor;

FIG. 22—perspective view of the pulling mechanism of FIG. 19 without the upper conveyor and without the stretcher mechanism;

FIG. 23—perspective rear view of the module supporting frame in accordance with the present invention;

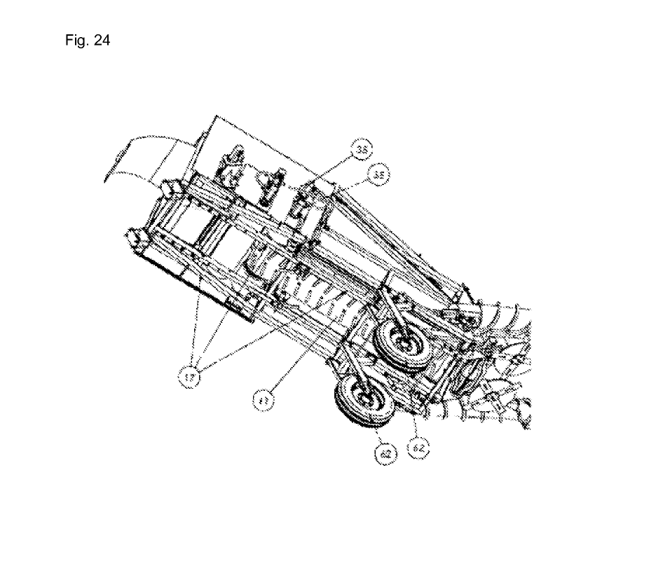

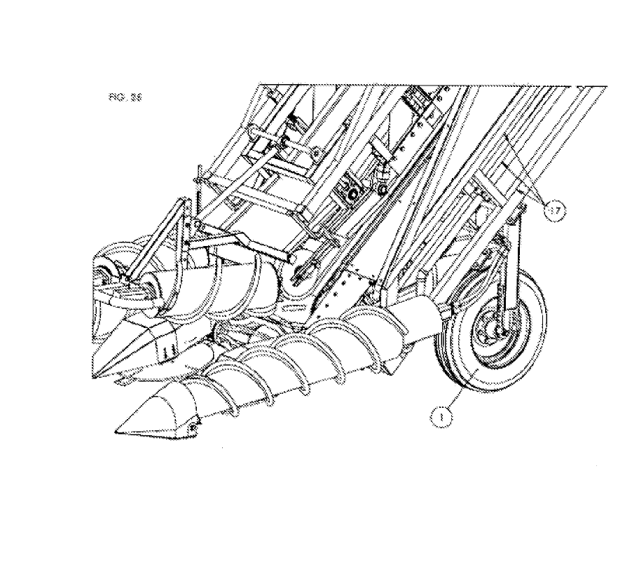

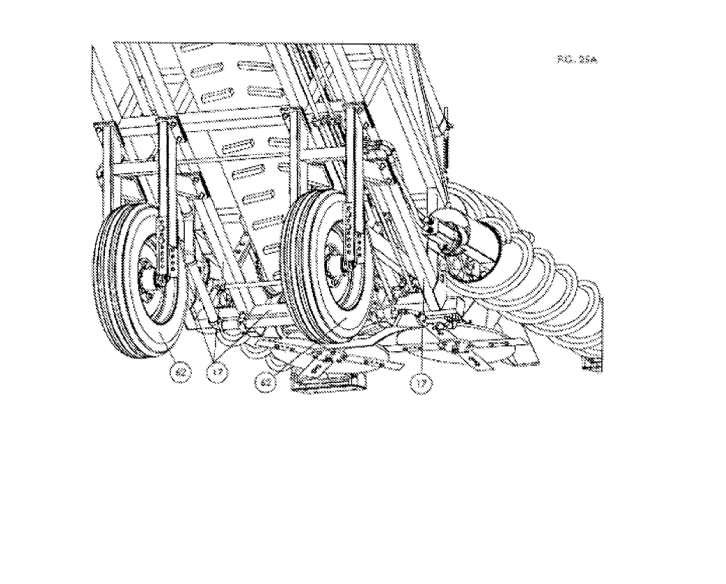

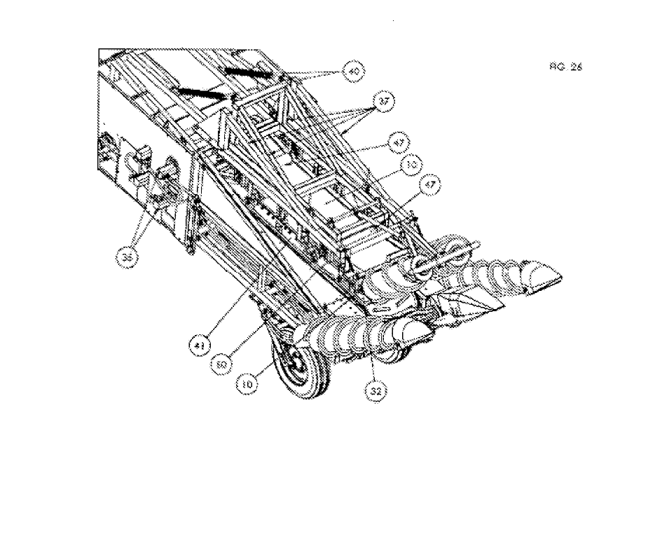

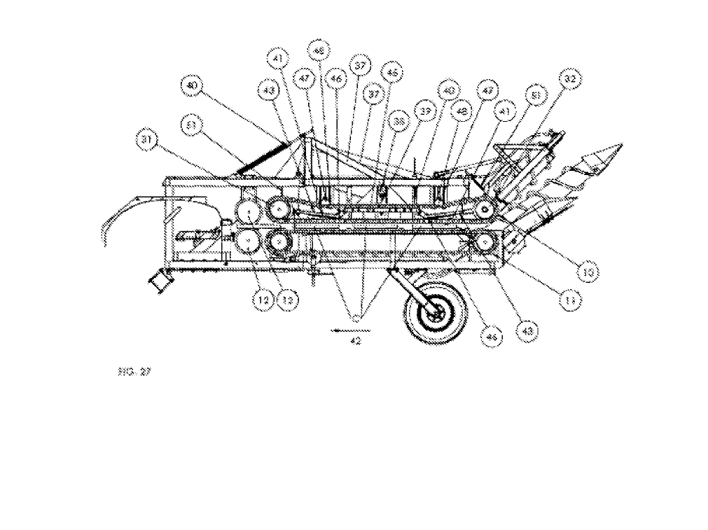

FIG. 24—lower view of the complete supporting frame of the module in accordance with the present invention;

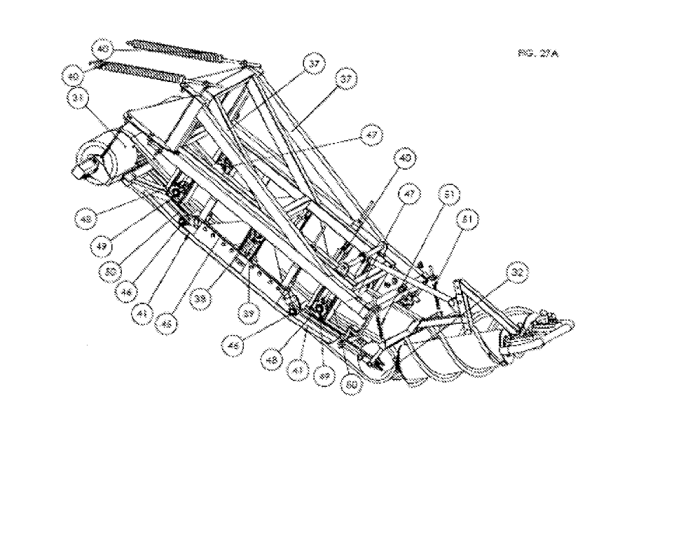

FIG. 25—front view of the lower part of the module supporting frame in accordance with the present invention;

FIG. 25th—rear view on the lower part of the module supporting frame in accordance with the present invention;

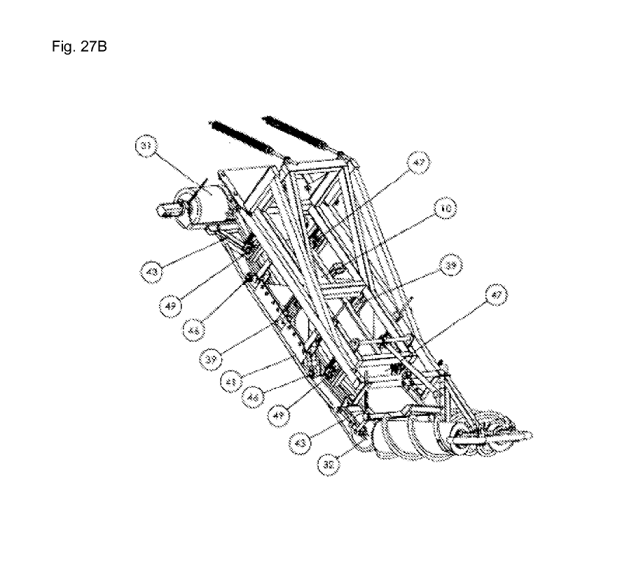

FIG. 26—perspective view of a preferred embodiment of the stretcher mechanism in accordance with the present invention;

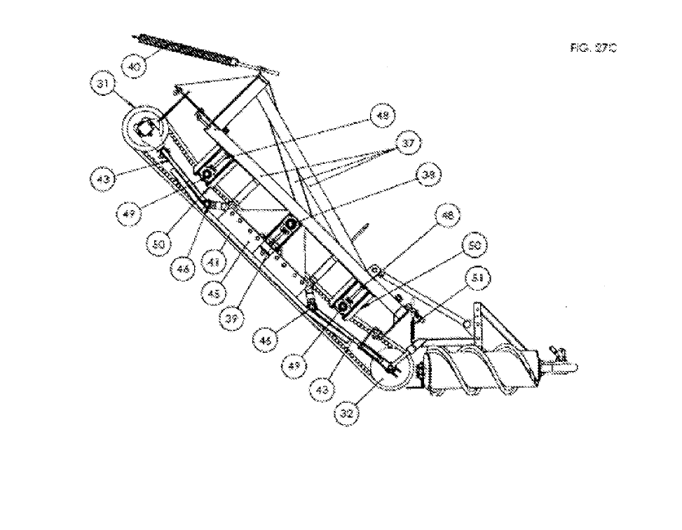

FIG. 27—lateral view of the stretcher mechanism of FIG. 26;

FIGS. 27A to 27D—views of the stretcher mechanism of FIG. 26;

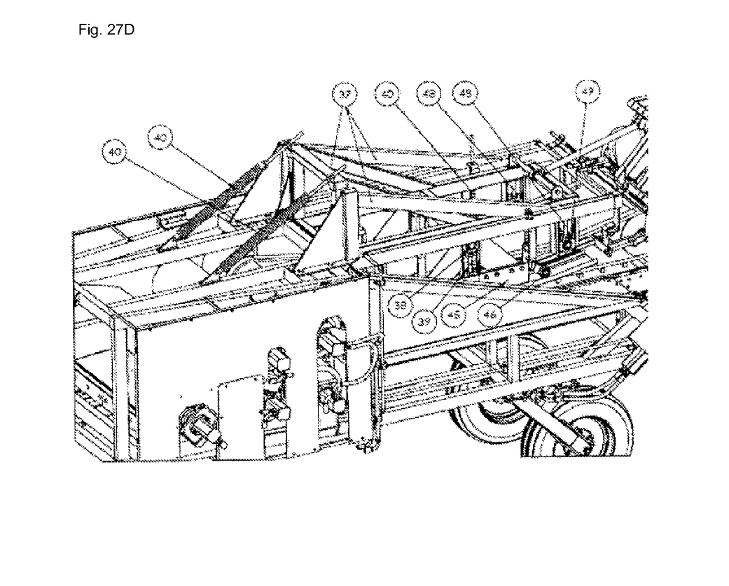

FIG. 28—lateral view of a preferred embodiment of the transferring mechanism in accordance with the present invention and of the upper part of the stretcher mechanism of FIG. 26;

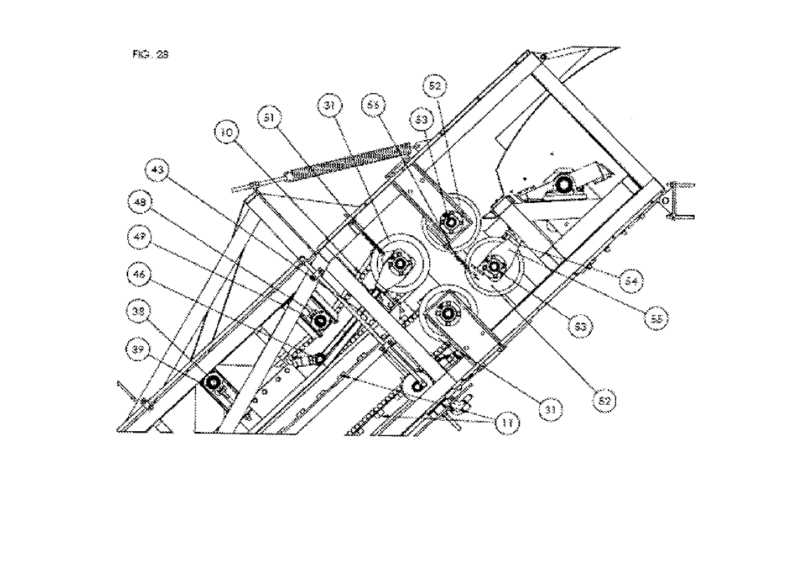

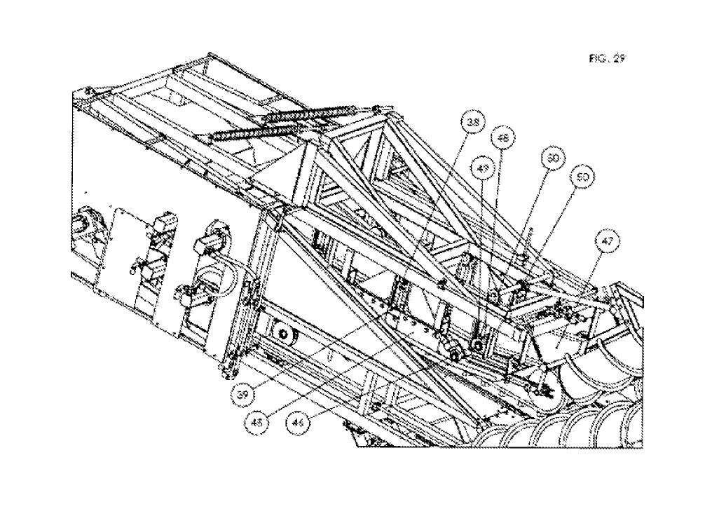

FIG. 29—upper view of the stretcher mechanism of FIG. 26;

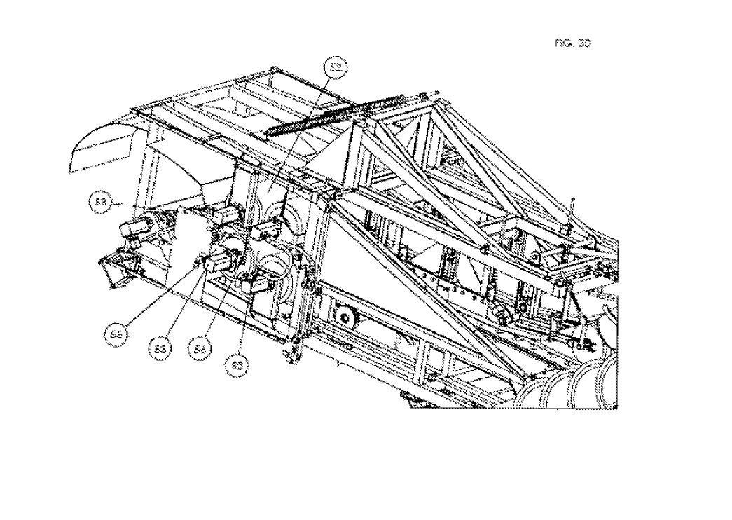

FIG. 30—perspective view of a preferred embodiment of the transferring mechanism and of the superior part of the stretcher mechanism of FIG. 26;

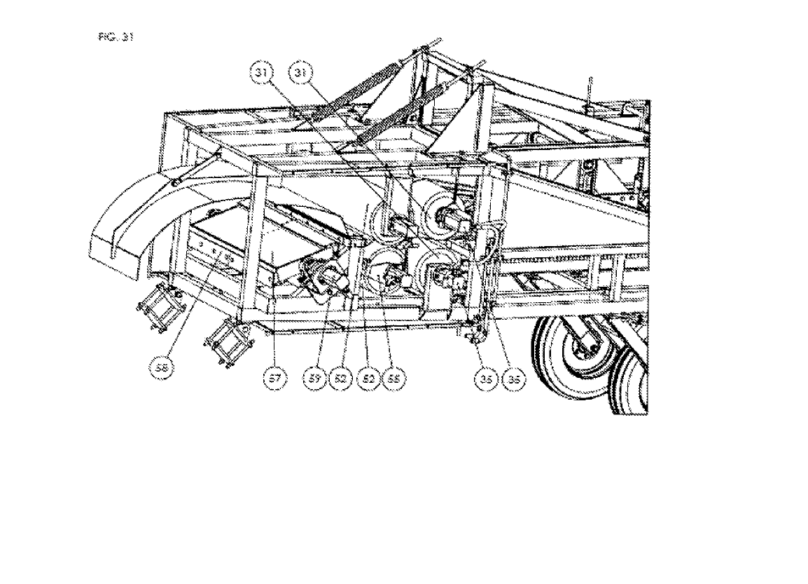

FIG. 31—perspective view of the transferring mechanism of FIG. 30 and of a preferred embodiment of the chopper mechanism;

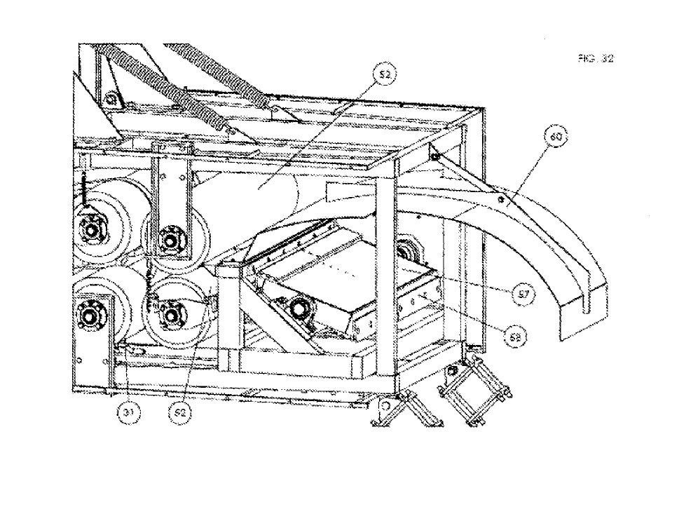

FIG. 32—perspective view of the chopper mechanism of FIG. 31; and

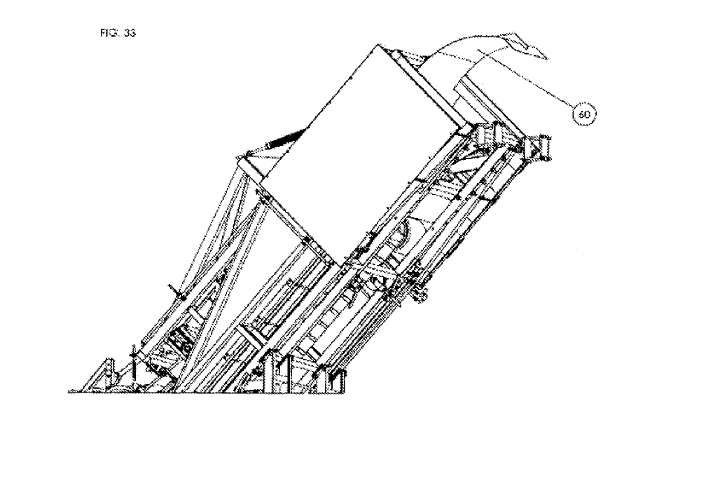

FIG. 33—lower view of the exit plate of the chopper mechanism.

FIGS. 1 to 5 show the general views of the module in accordance with the present invention, whereas the FIGS. 6 to 33 detail all the mechanisms that compose the module.

FIGS. 1 to 5 show a preferred embodiment of the module in accordance with the present invention, wherein it is observed a lifting mechanism 1 which comprises two revolving metallic cones 2 with respective helicoids 3 arranged on its surface. The tips 4 of the metallic cones 2, preferably, are not revolving and are kept touching the ground, lifting the sugar cane stems lied down on the ground transversely to the direction of the module displacement. Nowadays, due to bigger productivity of cane plantation, the stems achieve bigger heights and many of them frequently laid down transversely on the ground and need to be lifted before cutting. Additionally, the stems that remain erect in the plantation are lied down longitudinally by a deflector 5 of a deflector mechanism 6 for afterward harvesting. Hence, with all lifted stems or stems bent longitudinally in the direction of the module displacement, a base cutting mechanism 7 cuts the stems near root. Following, the deflector mechanism 6 and a lifting roll 8 transfer the stems to a pulling mechanism 9, which holds tight the stems between its conveyors, upper conveyor 10 and lower conveyor 11. Said conveyors transport the stems up and transfer them to a transferring mechanism 12, which in turn, transfers them to a chopper mechanism 13. A stretcher mechanism 14 supports and stretches the upper conveyor 10, as well as regulates the distance between said conveyors 10 and 11.

Then, after the module effects all the working steps, the straw is moved by a flow of air and the pieces of cane of approximately 20 cm are dumped in a bucket truck.

### Lifting Mechanism (see FIGS. 6 to 8)

FIGS. 6 to 8 detail the lifting mechanism 1 that comprises the revolving metallic cone 2 with the helicoid arranged on its surface 3 and with a tip 4, preferably, not revolving, and which slides touching the ground during the operation of the module. The cone 2 is operated by a motor 15, preferably a hydraulic motor, and a mechanism oscillating axle 16 is fixable in the module supporting frame 17 (see FIG. 1). The oscillating axle 16 makes possible the cone be lifted and lowered, in way to follow the terrain variation.

### Base Cutting Mechanism (see FIGS. 12 to 16 and 19)

The base cutting mechanism 7 comprises preferably, two cutting devices oppositely placed to each other, each device being driven by a motor 18 and comprising a disc 19 where cutting knives 20 are fixed, said discs having an inclination forward preferably of 12°. The motors 18 are protected by protection plates 21 and each cutting device is fixed by a rod 22 and the module structure 17.

FIGS. 13 to 16 do not show the protection plates 21.

### Deflector Mechanism (see FIGS. 9, 10 and 11)

The deflector mechanism comprises a deflector 5 and, preferably, two revolving metallic cylinders 23 with a helicoids 24 arranged on its surface, said cylinders being operated, respectively, by a motor 25 and arranged, preferably, horizontally. The deflector mechanism structure 26 is fixed by rods 27 to the module structure.

Hence, in the case of lied down canes transversely to the direction of module displacement, the metallic cone 2 lifts the cane, without displacing the stem in the direction of the movement, in way to minimize the force applied in the root, and then cutting knives 20 cut off said cane, making it falling down over the metallic cone 2. Therefore, the end of the cane, where the cutting happens, climbs up, making the cane to touch the lower part of the metallic cylinder 23. Thus, with an end of the cane supported on the upper part of the cone 2, and another end touched at the lower part of the cylinder 23, said cane is moved backwards, through the rotation of the helicoids 3 and 23, until it reaches the conveyors 10 and 11 of the pulling mechanism 9, which pull the cane and transfer it to the transferring mechanism 12, which in turn, transfers the cane to the chopper mechanism 13. In case of bent canes, the same steps described above take place, wherein in this case the canes do not need to be lifted by metallic cones 2, since they are bent and are not laterally lied down.

In case of erect canes, the deflector 5 inclines the cane longitudinally, without effecting any effort at the root of said cane, the cut knives 20 cut the cane, and the lifting roll 8 lifts the end of the cane and transfer it to the conveyors 10 and 11 of the pulling mechanism, which transfer the cane to the transferring mechanism 12, which in turn transfers it to the chopper mechanism 13. In case of canes lied down longitudinally forward or backward, the same previously described steps take place for the erect canes.

In case of erect canes or longitudinally lied down canes, the cones 2 and the cylinders 23 of deflector mechanism 6 has not function.

### Lifting Roll (see FIGS. 9, 16, 17 and 18)

The lifting roll 8 is positioned near to the lower end of the upper 10 and lower 11 conveyors, is driven preferably, by a hydraulic motor 28 and is supported at the ends by bearings 29 assembled on a frame 30.

### Pulling Mechanism (see FIGS. 10, 18 to 22, 24, 26 and 31)

The pulling mechanism comprises preferably, two conveyors, an upper conveyor 10 and a lower conveyor 11, said conveyors being assembled, each one, preferably, in a upper roll 31 and a lower roll 32, each conveyor comprising, in the center, at the internal surface, a longitudinal rib 33 with transverse grooves, said rib acting in a chamfer at the middle of the rolls 31 and 32, so that the conveyors do not move out from the rolls. One of the rolls of each conveyor, preferably the upper rolls 31, are operated by a hydraulic motor 35, while the lower rolls 32 are driven.

It is still observed in the figures that the lower conveyor presents clefts 36 at the outer surface, which serves to increase the friction with the canes and, therefore, improving the displacement of said canes.

In the FIGS. 21 and 22, the upper conveyor 10 is not shown, in order to facilitate the visualization of the lower conveyor 11.

### Stretcher Mechanism (see FIGS. 10, 26, 27, 27A, 27B, 27C, 27D, 28 and 29)

The stretcher mechanism 14 comprises a movable structure 37 with a roller-bearing 38 that articulates the whole structure of the mechanism 37, in such bearing is disposed a screwed tuning rod 39 for the adjustment of the distance between upper 10 and lower 11 conveyors. The bearing 38 and springs 40 make possible the structure to oscillate and return back to its position. A plate 41, with ends bent up, is fixed in the structure 15 of the mechanism 37 and spans in the whole width of the upper conveyor 10. The plate 41 leans in the internal lower surface of the upper conveyor 10 and is used to avoid the deformation of the conveyor 10, when the sugar cane stems C are being pressed and transported between said conveyors 10 and 11 (see FIG. 27). The arrow 42 indicates the displacement of the stems.

It is still observed from figures that the structure 37 has oscillating arms 43 with an end fixed on the center of the rolls 31 and 32 of the upper conveyor 10, and the other end fixed on a rod 45, which is assembled in the screwed rod 39 and presents kneecaps 46 at the ends. The stretcher mechanism has also rollers 47 fixed in screwed rods 48 for tension tuning, such rollers pushing down the upper surface of superior conveyor 10, keeping said conveyor 10 stretched. The rollers are installed in roller-bearing 49, which are assembled in the respective structures 50, where also the screwed rods 48 are assembled.

Hence, when the conveyors 10 and 11 of the pulling mechanism 9 pulls the sugar cane stems C, the lower roll 32, together the lower oscillating arm 43 raised up, and the stem passes, and the plate 41 keeps the lower part of the conveyor 10 stretched, without deformation. When the stem finishes the passage between the conveyors, the upper roll 31 and the oscillating arm 43 stand up, and the stem C is transferred to the transferring mechanism 12. Repositioning springs 51 act in the rolls 31 and 32, so that said rolls return to the respective positions. When the stems C pass, the structure 37 also oscillates in the bearing 38, and the springs 40 guarantee the return of said structure to its position.

### Transferring Mechanism (see FIGS. 28, 30 and 31)

The transferring mechanism 12 comprises two rolls 52 driven, respectively, by a motor 53, said rolls 52 being arranged in parallel and revolving in opposite way, and being that one of the rolls is mobile and can be offset from another roll through a distance variation device 54. Said distance variation device 54 comprises articulating arms 55, where the movable roll is fixed, and springs 56.

### Chopper Mechanism (see FIGS. 31, 32 and 33)

The chopper mechanism 13 comprises a body 57 with at least a cutting knife 58, wherein said body is revolved by a motor 59. A gutter 60, with an approximately circle shape, drives the cut pieces of cane.

### Module Supporting Frame (see FIGS. 23, 24, 25 and 25A)

The figures show the module supporting frame 17 wherein the wheels 62 are assembled.

Further to the embodiments previously presented, the same inventive concept can be applied to other alternatives or possible uses of the invention, as for example, instead of hydraulic motors, pneumatic motors can be used. Moreover, the deflector mechanism can be simplified and, instead of the convergent cylinders, it can be constructed by a plate or bars.

Therefore, it will be comprised that the present invention should be interpreted in a comprehensive way, being its scope determined by the terms of the attached claims.

1.-18. (canceled)

19. A harvesting conveyors module, particularly appropriated for sugar cane harvesting, comprising a lifting mechanism (1); a base cutting mechanism (7); a deflector mechanism (6) arranged above the lifting mechanism (1); a pulling mechanism (9) comprising conveyors, an upper conveyor (10) and a lower conveyor (11); a transferring mechanism (12) appropriate to receive the stems from the pulling mechanism (9) and transfer them to a chopper mechanism (13), said chopper mechanism (13) being arranged in sequence to said transferring mechanism (12), wherein comprises the lifting mechanism (1) arranged horizontally and being able to be vertically moved accompanying the undulation of the ground; a lifting roll (8) placed near the lower end of the conveyors (10, 11); a stretcher mechanism (14) acting in the upper conveyor (10) of the pulling mechanism (9), and the deflector mechanism (6) comprising a deflector (5) and, preferably, two revolving metallic cylinders (23) with a helicoid (24) arranged on its surface, said cylinders being operated, respectively, by a motor (25) and being arranged, preferably, horizontally.

20. A module as claimed in claim 19, wherein the lifting mechanism (1) comprises at least a revolving metallic cone (2) with a helicoid (3) arranged on its surface (3) and with a tip (4), preferably, not revolving, said cone being operated by a motor (15), and having an oscillating axle (16) which is a fixable in the module supporting frame (17).

21. A module as claimed in claim 19, wherein the stretcher mechanism (14) comprises a movable structure (37), the structure having oscillating arms (43), each arm (43) presenting an end fixed on the center of a roll (31, 32) of the upper conveyor (10) and the other end fixed on a bar (45) through kneecaps (46); the mechanism comprising also rollers (47) that act in the upper surface of the upper conveyor (10), stretching said conveyor, springs of repositioning the movable structure (40) and springs of repositioning the rolls (51).

22. A module as claimed in claim 21, wherein the rollers (47) are installed in roller bearing (49), which are assembled in the respective structures (50) which have a screwed rod for adjusting the tension (48).

23. A module as claimed in claim 21, wherein the stretcher mechanism (14) comprises additionally a roller bearing (38) that articulates the whole structure of the mechanism (37), in the bearing being disposed a screwed rod (39) for adjusting the distance between the upper conveyor (10) and the lower conveyor (11), and a plate with bent ends up (41) fixed on the structure of the mechanism (37), is disposed leaning in the bottom internal surface of the superior conveyor (10).

24. A module as claimed in claim 19, wherein the base cutting mechanism (7) comprises, preferably, two cutting devices oppositely situated to each other, each device being operated by a motor (18) and comprising a disc (19) where cutting knives (20) are fixed, said discs (19) having an inclination forward, preferably by 12°.

25. A module as claimed in claim 19, wherein the pulling mechanism (9) comprises, preferably, two conveyors, an upper conveyor (10) and a lower conveyor (11), said conveyors being assembled, each one, preferably, in a upper roll (31) and a lower roll (32), and being at least one of the rolls of each conveyor operated by a motor (35).

26. A module as claimed in claim 25, wherein the upper rolls (31) are operated and the lower rolls (32) are driven, and the inferior conveyor (32) has clefts (36) on its outer surface.

27. A module as claimed in claim 25, wherein each conveyor comprises in the center, in the internal surface, a longitudinal rib (33) with transverse grooves, such rib acting in a chamfer placed at the center of rolls (31, 32).

28. A module as claimed in claim 19, wherein the transferring mechanism (12) comprises two rolls (52) operated, each one, by a motor (53), said rolls (52) being arranged in parallel and revolving in opposite senses, and being one of the rolls movable and can move away from another roll through a distance variation device (54, 55, 56).

29. A module as claimed in claim 28, wherein the distance variation device (54, 55, 56) comprises articulating arms (55), where there is fixed the movable roll (52) and springs (56).

30. A module as claimed in claim 19, wherein the chopper mechanism (13) comprises a body (57) with at least a cutting knife (58), and said body being rotated by a motor (59).

31. A process for harvesting the erect sugar cane, using a conveyors module as defined in the claim 19, wherein comprises, sequentially, the following steps:
a) a deflector (5) inclines the cane longitudinally, without moving the stem in the direction of the movement, in way to minimize the forces applied in the root;
b) cutting discs (19) cut the cane;
c) a lifting roll (8) lifts the end of the cane and transfers it to conveyors (10,11); and
d) the conveyors (10,11) of a pulling mechanism (9) pull the cane, and a transferring mechanism (12) transfers the cane to a chopper mechanism (13), which cuts the cane in pieces.

32. A process for harvesting the laterally bent sugar cane, using a conveyors module as defined in the claim 19, wherein comprises, sequentially, the following steps:
a) a cutting disc (19) cuts the cane without effecting any effort at the root of said cane, and the cane, therefore, falls on the upper surface of a metallic cone (2) of the lifting mechanism (1);
b) the other end of the cane, consequently, climbs up and touches the lower surface of a cylinder (23) of a deflector mechanism (6);
c) the helicoids (3) of the metallic cone (2) and the helicoids (24) of the cylinder (23), through rotation, move the cane up to the conveyors (10, 11) by a pulling mechanism; and
d) the conveyors (10,11) of the pulling mechanism pull the cane up to a transferring mechanism (12), and the transferring mechanism (12) transfers the cane to a chopper mechanism (13), which cuts the cane in pieces.

33. A process for harvesting laterally lied down sugar cane, using a conveyors module as defined in the claim 19, wherein comprises, sequentially, the following steps:
a) a metallic cone (2) of a lifting mechanism (1) lifts a little the cane, without moving the stem in the direction of the movement, in way to minimize the forces applied in the root;
b) a cutting disc (19) cuts the cane, and the cane, consequently, falls on the superior surface of the metallic cone (2);
c) the other end of the cane, consequently, climbs up and touches the lower surface of a cylinder (23) of a deflector mechanism (6);
d) the helicoids (3) of the metallic cone (2) and the helicoids (24) of the cylinder (23), through rotation, move the cane up to the conveyors (10, 11) of a pulling mechanism (9); and
e) the conveyors (10, 11) of the pulling mechanism pull the cane, and a transferring mechanism (12) transfers the cane to a chopper mechanism (13), which cuts the cane in pieces.

34. A process for harvesting sugar cane lied down longitudinally forward or backwards, using a conveyors module as defined in the claim 19, wherein comprises, sequentially, the following steps:
a) the cutting disc (19) cuts the cane without effecting any effort at the root of said cane;
b) a lifting roll (8) lifts the end of the cane and transfers it to conveyors (10, 11) of a pulling mechanism (9); and
c) the conveyors (10, 11) of the pulling mechanism (9) pull the cane, and a transferring mechanism (12) transfers the cane to a chopper mechanism (13), which cuts the cane in pieces.
